(19) United States
(12) Patent Application Publication
(10) Pub. No.: US 2014/0283965 A1
(43) Pub. Date: Sep. 25, 2014

(54) PNEUMATIC TIRE

(71) Applicant: TOYO TIRE & RUBBER CO., LTD., Osaka (JP)

(72) Inventor: Souichi Takahashi, Osaka-shi (JP)

(73) Assignee: TOYO TIRE & RUBBER CO., LTD., Osaka (JP)

(21) Appl. No.: 14/221,890

(22) Filed: Mar. 21, 2014

(30) Foreign Application Priority Data
Mar. 22, 2013 (JP) 2013-060391

(51) Int. Cl. B60C 11/13; B60C 11/00

(52) U.S. Cl. CPC B60C 11/1376; B60C 11/0008; B60C 2011/0025
USPC 152/209.5; 152/209.15

(57) ABSTRACT

A pneumatic tire is provided with a pair of first land sections formed between shoulder main grooves and center main grooves, a second land section formed between the center main grooves, and a pair of shoulder land sections formed on the outside of the shoulder main grooves in a tire width direction. The first land sections and the second land section swell outward in the tire radial direction from a basic tread profile line that smoothly connects ground contact surfaces of the pair of shoulder land sections. A swelling amount of the first land sections that swell from the basic tread profile line is larger than a swelling amount of the second land section.

### BACKGROUND OF THE INVENTION

1. Field of the Invention

The present invention relates to a pneumatic tire.

2. Background Art

Recently, a high fuel efficiency is demanded even in a pneumatic tire. In order to improve the fuel efficiency of the tire, a technique in which a tread section is formed of a low exothermic rubber composition to reduce a rolling resistance has been proposed.

However, the low exothermic rubber composition has a low rubber hardness and a low loss tangent (tan δ). If the tread section is formed of the low exothermic rubber composition, a cornering power is reduced and an operation stability performance deteriorates. Thus, it is necessary to reduce the rolling resistance, to improve the fuel efficiency and to maintain the high operation stability performance.

In this regard, JP-A-2007-69665 discloses a pneumatic tire in which a first cap compound layer with a low tan δ is disposed on a center side of a tread section, a second cap compound layer with a high tan δ is disposed on a shoulder side of the tread section and the center side of the tread section swells outward in a tire radial direction. This pneumatic tire employs a tire profile in which only the first cap compound layer is in contact with the ground under a low load such as normal traveling, and the second cap compound layer is also in contact with the ground under a high load such as braking or cornering, in addition to the first cap compound layer.

JP-A-2005-263180 discloses a pneumatic tire including a tread section provided with plural circumferential main grooves that extend in a tire circumferential direction and a rib formed between the circumferential main grooves, in which the rib swells outward in a radial direction from an arc-shaped contour line L of a radius R passing through a front surface of a shoulder rib.

Further, JP-A-2005-319890 discloses a pneumatic tire including a tread section provided with a pair of main grooves that continuously extends in a tire circumferential direction on both sides of a tire equator and a center rib that is continuous in the tire circumferential direction and is formed between the pair of main grooves, in which the center rib swells outward in a tire radial direction from a virtual tread profile line that smoothly connects tread surfaces including both ground contact ends except for the center rib.

Further, JP-A-62-241709 discloses a pneumatic radial tire in which a tread section is divided in a width direction into five regions of a pair of outer regions, a central region and a pair of intermediate regions disposed between the outer regions and the central region, by plural main grooves that extend in a circumferential direction, and a protruding section that swells outward in a radial direction is provided in the intermediate region.

### SUMMARY OF THE INVENTION

However, if the center portion of the tread section in the tire width direction swells outward in the tire radial direction as disclosed in JP-A-2007-69665, JP-A-2005-263180, and JP-A-2005-319890, there is a problem in that the operation stability is enhanced by enlargement of a ground contact area, but a ground contact length of the center portion in the tire width direction becomes relatively large compared with the other sections, and thus, the rolling resistance increases.

Further, if only the intermediate regions disposed between the outer regions and the central region of the tread section swell outward in the tire radial direction as disclosed in JP-A-62-241709, there is a problem in that only the intermediate sections are in contact with the ground under a low load, and thus, a ground contact area decreases, which deteriorates the operation stability.

An object of the invention is to provide a pneumatic tire capable of achieving a high fuel efficiency and a high operation stability.

According to an aspect of the invention, there is provided a pneumatic tire including a tread section that is provided with: a plurality of center main grooves that extends in a tire circumferential direction; a pair of shoulder main grooves that is provided on the outside of the plurality of center main grooves in a tire width direction and extends in the tire circumferential direction; a land section that is formed on the inside of the pair of shoulder main grooves in the tire width direction; and a pair of shoulder land sections that is formed on the outside of the pair of shoulder main grooves in the tire width direction, in which the land section includes a pair of first land sections formed between the shoulder main grooves and the center main grooves, and a second land section formed between the center main grooves, the first land sections and the second land section swell outward in a tire radial direction from a basic tread profile line that smoothly connects ground contact surfaces of the pair of shoulder land sections, and a swelling amount of the first land sections from the basic tread profile line is larger than that of the second land section.

According to a preferable aspect of the invention, in the pneumatic tire according to the above aspect of the invention, the shoulder land sections may include, compared with a first rubber composition that forms the first land sections and the second land section, a second rubber composition having a high rubber hardness and a high loss tangent (tan δ) at 60° C. Further, according to another aspect of the invention, in the pneumatic tire according to the above aspect of the invention, the first rubber composition may have a loss tangent (tan δ) of 0.10 or more to 0.20 or less measured at 60° C. and a rubber hardness of 50 or more to 60 or less, and the second rubber composition may have a loss tangent (tan δ) of 0.15 or more to 0.30 or less measured at 60° C. and a rubber hardness of 60 or more to 75 or less. Further, according to still another aspect of the invention, in the pneumatic tire according to the above aspect of the invention, the shoulder land sections may include an inner region positioned on the inside in the tire width direction and an outer region positioned between the inner region and a ground contact end. A length Xb of a ground contact surface of the outer region along the tire width direction may be ⅔ or less of a length X along the tire width direction from the ground contact end to the shoulder main groove. Further, according to still another aspect of the invention, in the pneumatic tire according to any one of the above aspects, the swelling amount of the first land sections may be set to 0.5 mm or more to 1.5 mm or less, and the swelling amount of the second land section may be set to 0.3 mm or more to 1.0 mm or less.

According to the invention, as the swelling amount in which the first land sections adjacent to the shoulder main grooves swell outward in the tire radial direction is larger than the swelling amount in which the second land section positioned at the center portion in the tire width direction swells outward in the tire radial direction, it is possible to increase the ground contact area of the first land sections and the second land section, and to enhance an operation stability. Further, as the ground contact lengths of the first land sections and the second land section are approximately equal to each other, it is possible to reduce a rolling resistance. Thus, it is possible to achieve a high fuel efficiency and a high operation stability.

### BRIEF DESCRIPTION OF THE DRAWINGS

FIG. 1 is a half-cross-sectional view illustrating a pneumatic tire according to a first embodiment.

FIG. 2 is a development view illustrating a tread pattern of the pneumatic tire according to the first embodiment.

FIG. 3 is an enlarged view of a section of FIG. 1, which is an enlarged cross-sectional view illustrating a main part of a tread section.

FIG. 4 is an enlarged cross-sectional view illustrating a main part of a tread section of a pneumatic tire according to a second embodiment.

FIG. 5 is a diagram illustrating a ground contact shape under a low load in the pneumatic tire according to the second embodiment.

FIG. 6 is a diagram illustrating a ground contact shape under a high load in the pneumatic tire according to the second embodiment.

### DETAILED DESCRIPTION OF THE INVENTION

### First Embodiment

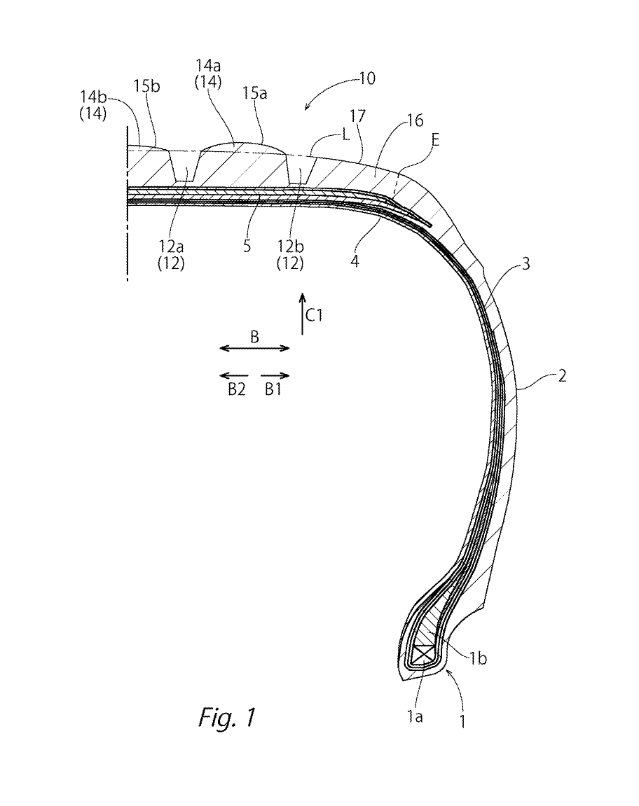

A pneumatic tire of the present embodiment shown in FIG. 1 is a radial tire that includes a pair of right and left bead sections 1, a pair of right and left side wall sections 2 that extends from the respective right and left bead sections 1 toward the outside C1 in a tire radial direction, a tread section 10 continuous an outer peripheral end of each of the right and left side wall sections 2, and a carcass 3 arranged to be stretched between the pair of bead sections 1.

In the bead section 1, an annular bead core 1a in which a bundle of steel wires or the like are covered with rubber, and a bead filler 1b of a triangular cross-section disposed on the outside C1 in the tire radial direction with reference to the bead core 1a are embedded.

The carcass 3 is wound so that the bead core 1a and the bead filler 1b are inserted therein, and its end portion is locked. An inner liner 4 for maintaining an air pressure is disposed inside the carcass 3.

A belt 5 that includes two or more layers of rubber-covered steel code layers is provided on an outer circumferential side of the carcass 3 in the tread section 10. The belt 5 reinforces the tread section 10 on the outer circumferential side of the carcass 3.

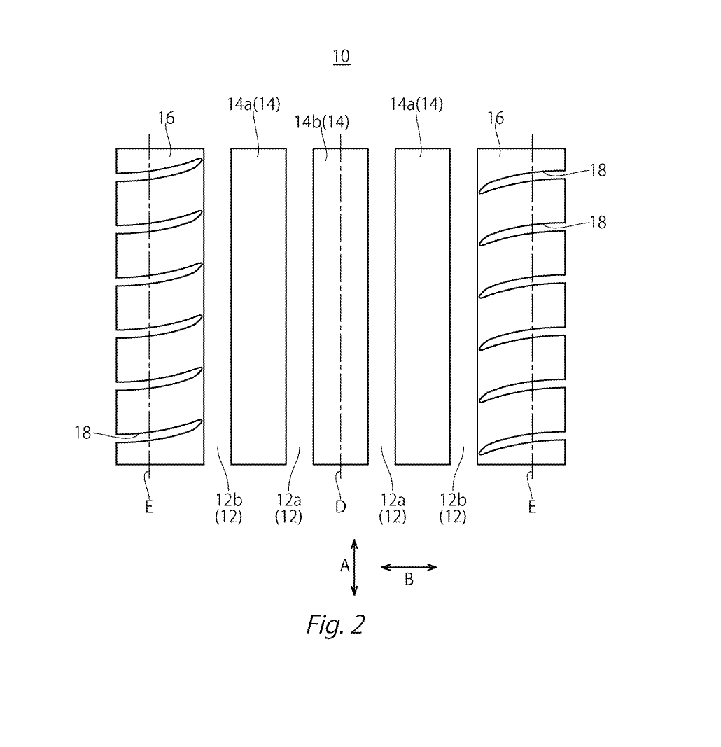

As shown in FIG. 2, on a surface of the tread section 10, plural center main grooves 12a that extend along a tire circumferential direction A, and a pair of shoulder main grooves 12b that is provided on the outside B1 in a tire width direction with reference to the plural center main grooves 12a and extends in the tire circumferential direction A. In this example, two center main grooves 12a disposed on both sides with a tire equator D being interposed therebetween, and two shoulder main grooves 12b that are respectively disposed on the outside B1 in the tire width direction with reference to the center main grooves 12a are provided on the surface of the tread section 10, that four main grooves 12 are provided in total.

In the tread section 10, due to the four main grooves 12, a land section 14 is formed on the inside B2 in the tire width direction with reference to the two shoulder main grooves 12b, and two shoulder land sections 16 are formed on the outside B1 in the tire width direction B1 with reference to the two shoulder main grooves 12b.

The land section 14 disposed between the two shoulder main grooves 12b includes a pair of first land sections 14a formed between the shoulder main grooves 12b and the center main grooves 12a, and a second land section 14b that is formed between the two center main grooves 12a and is disposed between the pair of first land sections 14a.

Plural transverse grooves 18 that extend in a direction intersecting with the tire circumferential direction A are provided in the tire circumferential direction A at predetermined intervals in the shoulder land section 16. The transverse grooves 18 extend toward the outside B1 in the tire width direction over a tread ground contact end E from the inside B2 in the tire width direction with reference to the tread ground contact end E. The grooves 18 are opened toward a tread side edge, and are terminated in the shoulder land section 16 so as not to be opened toward the shoulder main groove 12b.

As shown in FIG. 2, the first land sections 14a and the second land section 14b are continuous in the tire circumferential direction A without being divided in the tire circumferential direction A. In the shoulder land section 16, the plural transverse grooves 18 that extend in the direction intersecting with the tire circumferential direction A are provided in the tire circumferential direction A at the predetermined intervals. The first land sections 14a and the second land section 14b may form a block row in which plural blocks divided by transverse grooves are arranged in the tire circumferential direction A, and the shoulder land sections 16 may be continuous in the tire circumferential direction A without being divided in the tire circumferential direction A.

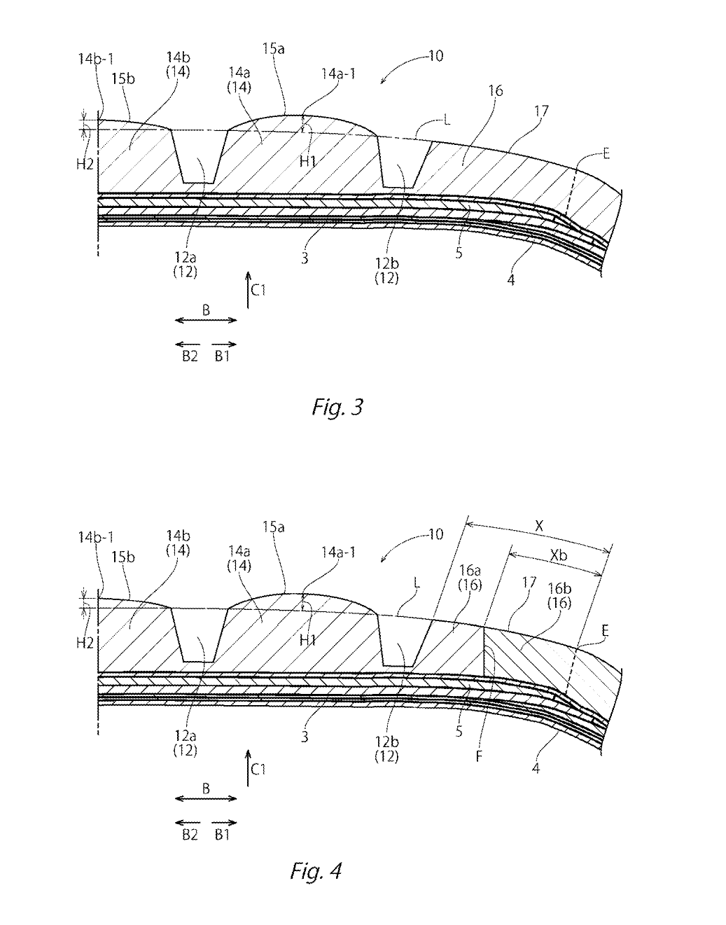

As shown in FIGS. 1 and 3, the first land sections 14a and the second land section 14b that form the land section 14 swell toward the outside C1 in the tire radial direction from a basic tread profile line L.

More specifically, the basic tread profile line L is a curve that is obtained by connecting plural arcs between tangent points having a common tangential line and smoothly connects ground surfaces 17 of the pair of shoulder land sections 16. The first land sections 14a and the second land section 14b swell toward the outside C1 in the tire radial direction from the basic tread profile line L so that a center portion thereof in the width direction B protrudes to the maximum. Thus, ground contact surfaces 15a and 15b of the first land sections 14a and the second land section 14b form an arc shape in which peaks 14a-1 and 14b-1 are positioned at center portions thereof in the width direction B.

A swelling amount H1 of the first land sections 14a from the basic tread profile line L, that is, a distance from the peak 14a-1 of the first land section 14a to the basic tread profile line L is larger than a swelling amount H2 (a distance from the peak 14b-1 of the second land section 14b to the basic tread profile line L) of the second land section 14b from the basic tread profile line L.

The swelling amount H1 of the first land sections 14a and the swelling amount H2 of the second land section 14b are not particularly limited as long as the swelling amount H1 is larger than the swelling amount H2, but if the swelling amount H1 of the first land sections 14a and the swelling amount H2 of the second land section 14b are excessively small, a ground contact area is reduced to deteriorate the operation stability, and if the swelling amount H1 of the first land sections 14a and the swelling amount H2 of the second land section 14b are excessively large, the shoulder land section 16 does not easily come into contact with the ground under a high load such as braking or cornering, and thus, the operation stability under the high load deteriorates. For this reason, it is preferable that the swelling amount H1 of the first land sections 14a be set to 0.5 mm or more to 1.5 mm or less, and the swelling amount H2 of the second land section 14b be set to 0.3 mm or more to 1.0 mm or less.

Further, in the present embodiment, in order to prevent deterioration of a rolling resistance due to a non-uniform ground contact pressure distribution of the first land sections 14a and the second land section 14b, it is preferable that the peaks 14a-1 and 14b-1 that most swell toward the outside C1 in the radial direction in the first land sections 14a and the second land section 14b be respectively in the range of 30% of the total widths of the ground contact surfaces 15a and 15b with reference to the centers of the ground contact surfaces 15a and 15b in the tire width direction B.

In the pneumatic tire of the above-described embodiment, the swelling amount H1 of the first land sections 14a adjacent to the shoulder main grooves 12b is larger than the swelling amount H2 of the second land section 14b disposed on the inside B2 in the tire width direction with reference to the first land sections 14a. Thus, it is possible to increase the ground contact area in the first land sections 14a and the second land section 14b while uniformly maintaining a ground contact length of the first land sections 14a and the second land section 14b, and to achieve a high fuel efficiency and a high operation stability performance.

### Second Embodiment

Next, a second embodiment will be described with reference to FIGS. 4 to 6.

A pneumatic tire according to the present embodiment is different from the first embodiment in that the shoulder land section 16 includes different rubber compositions, differently from a rubber composition that forms the first land sections 14a and the second land sections 14b.

Specifically, as shown in FIG. 4, the shoulder land section 16 includes an inner region 16a positioned on the inside B2 in the tire width direction, and an outer region 16b adjacent to the inner region 16a on the outside B1 in the width direction. Reference F in FIG. 4 represents a boundary line between the inner region 16a and the outer region 16b.

The inner region 16a is a region that is disposed between the shoulder main groove 12b and the boundary line F and is formed of a first rubber composition that is the same material as that of the first land sections 14a and the second land section 14b. The outer region 16b is a region that is disposed between the boundary line F and the ground contact end E and is formed of a second rubber composition having a high rubber hardness and a high loss tangent (tan δ) at 60° C., compared with the first rubber component.

In the present embodiment, the rubber hardness refers to a hardness measured at 25° C. by a durometer hardness tester (type A) of JIS K6253, and the loss tangent (tan δ) refers to tan δ measured under the conditions of an initial distortion of 15%, a dynamic distortion of ±2.5%, a frequency of 10 Hz and a temperature of 60° C. using a viscoelastic spectrometer made by UBM.

In the present embodiment, the first land sections 14a swell toward the outside C1 in the tire radial direction from the basic tread profile line L, and the shoulder land sections 16 includes the outer region 16b formed of the second rubber composition having the high rubber hardness and the high loss tangent (tan δ) at 60° C., compared with the first rubber component that forms the first land sections 14a and the second land sections 14b.

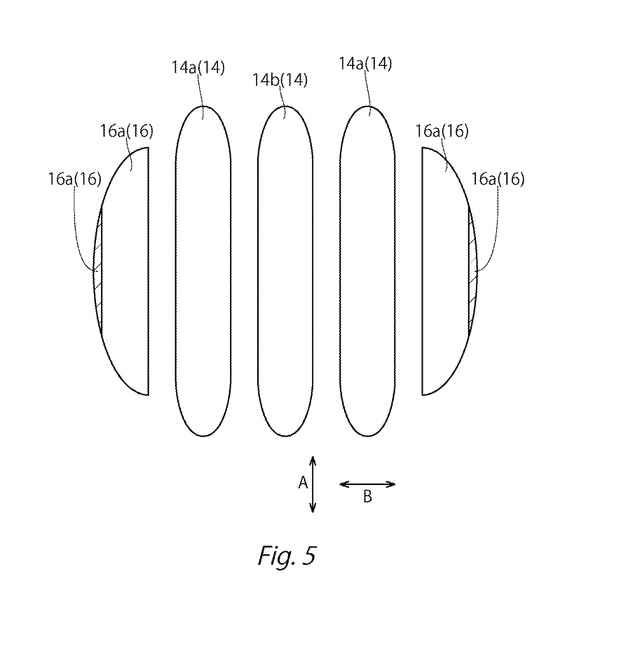

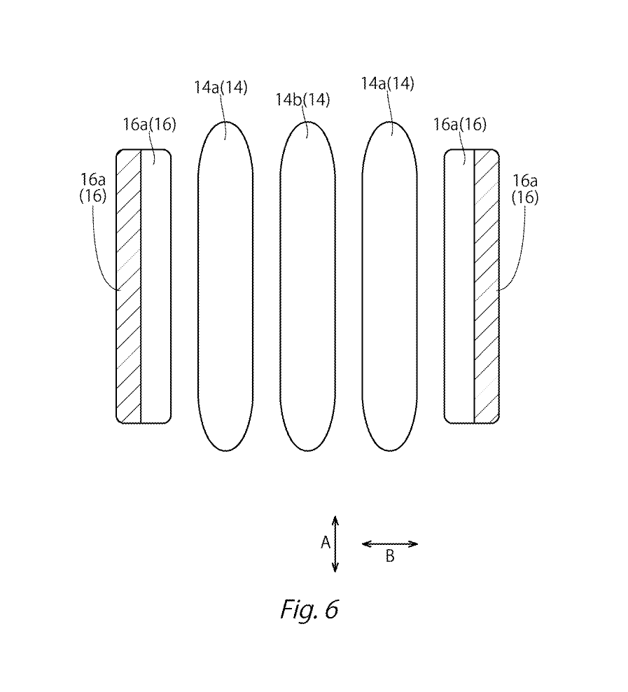

Thus, under a low load such as normal traveling, as shown in FIG. 5, the outer region 16b formed of the second rubber composition does not easily come into contact with the ground, and thus, it is possible to suppress deterioration of the rolling resistance due to the rubber composition having the high rubber hardness. Further, under a high load such as cornering, as shown in FIG. 6, the outer region 16b is in contact with the ground, and thus, it is possible to achieve a high cornering power to improve the operation stability.

As the first rubber composition that forms the first land sections 14a, the second land section 14b and the inner region 16a, and as the second rubber composition that forms the outer region 16b, as long as the rubber hardness and the loss tangent (tan δ) measured at 60° C. of the second rubber composition are higher than those of the first rubber composition, it is possible to use various tread rubber compositions. That is, the rubber hardness of the first rubber composition and the second rubber composition or the value of the loss tangent (tan δ) measured at 60° C. are not particularly limited. For example, as the first rubber composition, it is preferable that the loss tangent (tan δ) measured at 60° C. be in the range of 0.10 or more to 0.20 or less and the rubber hardness be in the range of 50 or more to 65 or less. Further, as the second rubber composition that forms the outer region 16b, it is preferable that the loss tangent (tan δ) measured at 60° C. be in the range of 0.15 or more to 0.30 or less and the rubber hardness be in the range of 60 or more to 75 or less.

Further, it is preferable that the outer region 16b formed of the second rubber composition be set so that a ratio (Xb/X) of the length Xb of the ground contact surface 17b along the tire width direction B (the length along the tire width direction B from the ground contact end E to the boundary line F) and the length X of the ground contact surface 17 of the shoulder land section 16 along the tire width direction B (the length along the tire width direction B from the contact ground end E to the shoulder main groove 12b) is ⅔ or less. If the length Xb of the ground contact surface 17b of the outer region 16b along the tire width direction B is larger than ⅔ of the length X of the shoulder land section 16 along the tire width direction B, the outer region 16b formed of the second rubber composition is easily in contact with the ground under a low load such as normal traveling, and thus, the rolling resistance increases and the fuel efficiency deteriorates.

The other configurations are the same as in the first embodiment, and the same effects are obtained.

### Examples

Hereinafter, examples of the invention will be more specifically described, but the invention is not limited to the examples.

Pneumatic radial tires (195/65R15) for passenger cars of Examples 1 to 3 and Comparative Examples 1 to 3 were manufactured for a test. The respective tires were the same in a basic tread pattern and a tire inner structure, and were manufactured by changing the specifications shown in Table 1.

Specifically, Example 1 corresponds to the above-described first embodiment, and is an example of a pneumatic tire in which the swelling amount H1 of the first land sections 14a is larger than the swelling amount H2 of the second land section 14b. Examples 2 and 3 correspond to the above-described second embodiment, and are examples of a pneumatic tire in which the swelling amount H1 of the first land sections 14a is larger than the swelling amount H2 of the second land section 14b and the outer region 16b formed of the second rubber composition having the high rubber hardness and the high loss tangent (tan δ) at 60° C. compared with the first land sections 14a and the second land section 14b is provided in the shoulder land section 16. Here, Example 2 is an example corresponding to a case where the ratio (Xb/X) of the length Xb of the ground contact surface 17b and the length X of the ground contact surface 17 is 0.6, and Example 3 is an example corresponding to a case where the ratio (Xb/X) is 0.8.

Comparative Examples 1 and 2 are examples of a pneumatic tire in which the first land sections 14a and the second land section 14b do not swell from the basic tread profile line L. Comparative Example 3 is an example of a pneumatic tire in which the first land sections 14a and the second land section 14b swell from the basic tread profile line L and the swelling amount H2 of the second land section 14b is larger than the swelling amount H1 of the first land sections 14a.

A cornering power (operation stability) and a rolling resistance performance (fuel efficiency) of each pneumatic tire of Examples 1 and 2 and Comparative Examples 1 to 3 was evaluated. An evaluation method is as follows.
Cornering power: A cornering force generated in a test tire under a low load (45% of the JATMA-defined maximum load) and under a high load (90% of the JATMA-defined maximum load) was measured using a drum tester of the diameter of 2500 mm, and a cornering power at a slip angle of 1° was obtained. Index evaluation was performed with an index of the result of Comparative Example 1 being set to 100. Here, as a numerical value of the index is large, the cornering power increases, and the operation stability performance is superior.
Rolling resistance: A rolling resistance of the tire under the low load (45% of the JATMA-defined maximum load) and under the high load (90% of the JATMA-defined maximum load) under the condition of a tire inner pressure of 200 kPa, a rim size of 15×6 JJ, a load of 4.2 kN and a speed of 80 Km/h was measured using a rolling resistance tester. Indexes are shown with an index of Comparative Example 1 being set to 100. Here, as the index is small, the rolling resistance decreases, and the fuel efficiency is superior.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Swelling amount H1 | | 0.5 | 0.5 | 0.5 | — | — | 0.3 |
| (mm) of first land | | | | | | | |
| section | | | | | | | |
| Swelling amount H2 | | 0.3 | 0.3 | 0.3 | — | — | 0.5 |
| (mm) of second land | | | | | | | |
| section | | | | | | | |
| Rubber | Inner | 65 | 60 | 60 | 65 | 60 | 65 |
| hardness | region | | | | | | |
| (°) | Outer | 65 | 70 | 70 | 65 | 70 | 65 |
| | region | | | | | | |
| Loss | Inner | 0.25 | 0.2 | 0.2 | 0.25 | 0.2 | 0.25 |
| tangent | region | | | | | | |
| tanδ | Outer | 0.25 | 0.3 | 0.3 | 0.25 | 0.3 | 0.25 |
| | region | | | | | | |
| Ratio of lengths | | — | 0.6 | 0.8 | — | 0.8 | — |
| of ground contact | | | | | | | |
| surfaces (Xb/X) | | | | | | | |
| Cornering | Low | 105 | 103 | 103 | 100 | 101 | 103 |
| power | load | | | | | | |
| | High | 105 | 107 | 109 | 100 | 104 | 103 |
| | load | | | | | | |
| Rolling | Low | 101 | 99 | 100 | 100 | 98 | 103 |
| resistance | load | | | | | | |
| | High | 100 | 100 | 102 | 100 | 106 | 105 |
| | load | | | | | | |

The result is shown in Table 1. In Comparative Example 3 in which the swelling amount H2 of the second land section 14b is larger than the swelling amount H1 of the first land sections 14a, compared with Comparative Example 1, the cornering power was improved and the operation stability was improved, whereas the rolling resistance increased under the low load and under the high load and the fuel efficiency deteriorated.

Further, in Comparative Example 2 in which the outer region 16b of the shoulder land section 16 is formed of the rubber composition with the high rubber hardness and the high loss tangent (tan δ) at 60° C., compared with Comparative Example 1, the cornering power (operation stability) was improved, whereas the rolling resistance increased under the high load and the fuel efficiency deteriorated.

On the other hand, in Example 1 in which the swelling amount H1 of the first land sections 14a is larger than the swelling amount H2 of the second land section 14b, compared with Comparative Example 1, the operation stability and the fuel efficiency increased under the low load and under the high load.

Further, in Examples 2 and 3 in which the outer region 16b of the shoulder land section 16 is formed of the rubber composition with the high rubber hardness and the high loss tangent (tan δ) at 60° C., compared with Example 1, the operation stability under the high load was further improved. In particular, in Example 2 in which the ratio (Xb/X) of the length Xb of the ground contact surface 17b and the length X of the ground contact surface 17 was set to 0.6, it was possible to improve the operation stability without deterioration of the fuel efficiency even under the high load.

1. A pneumatic tire comprising a tread section that is provided with:
a plurality of center main grooves that extends in a tire circumferential direction;
a pair of shoulder main grooves that is provided on the outside of the plurality of center main grooves in a tire width direction and extends in the tire circumferential direction;
a land section that is formed on the inside of the pair of shoulder main grooves in the tire width direction; and
a pair of shoulder land sections that is formed on the outside of the pair of shoulder main grooves in the tire width direction,
wherein the land section includes a pair of first land sections formed between the shoulder main grooves and the center main grooves, and a second land section formed between the center main grooves,
wherein the first land sections and the second land section swell outward in a tire radial direction from a basic tread profile line that smoothly connects ground contact surfaces of the pair of shoulder land sections, and
wherein a swelling amount of the first land sections from the basic tread profile line is larger than that of the second land section.

2. The pneumatic tire according to claim 1,
wherein the shoulder land sections include, compared with a first rubber composition that forms the first land sections and the second land section, a second rubber composition having a high rubber hardness and a high loss tangent (tan δ) at 60° C.

3. The pneumatic tire according to claim 2,
wherein the first rubber composition has a loss tangent (tan δ) of 0.10 or more to 0.20 or less measured at 60° C., and a rubber hardness of 50 or more to 60 or less, and
wherein the second rubber composition has a loss tangent (tan δ) of 0.15 or more to 0.30 or less measured at 60° C., and a rubber hardness of 60 or more to 75 or less.

4. The pneumatic tire according to claim 2,
wherein the shoulder land sections include an inner region positioned on the inside in the tire width direction, and an outer region positioned between the inner region and a ground contact end, and
wherein a length Xb of a ground contact surface of the outer region along the tire width direction is ⅔ or less of a length X along the tire width direction from the ground contact end to the shoulder main groove.

5. The pneumatic tire according to claim 1,
wherein the swelling amount of the first land sections is set to 0.5 mm or more to 1.5 mm or less, and the swelling amount of the second land section is set to 0.3 mm or more to 1.0 mm or less.

6. The pneumatic tire according to claim 2,
wherein the swelling amount of the first land sections is set to 0.5 mm or more to 1.5 mm or less, and the swelling amount of the second land section is set to 0.3 mm or more to 1.0 mm or less.

7. The pneumatic tire according to claim 3,
wherein the swelling amount of the first land sections is set to 0.5 mm or more to 1.5 mm or less, and the swelling amount of the second land section is set to 0.3 mm or more to 1.0 mm or less.

8. The pneumatic tire according to claim 4,
wherein the swelling amount of the first land sections is set to 0.5 mm or more to 1.5 mm or less, and the swelling amount of the second land section is set to 0.3 mm or more to 1.0 mm or less.
